(19) United States
(12) Patent Application Publication
(10) Pub. No.: US 2025/0107870 A1
(43) Pub. Date: Apr. 3, 2025

(54) DEVICE FOR MOVING AN UPPER MOLAR

(71) Applicant: Jan DE BAETS, Versoix (CH)

(72) Inventor: Jan DE BAETS, Versoix (CH)

(21) Appl. No.: 18/844,098

(22) PCT Filed: Mar. 7, 2023
(86) PCT No.: PCT/IB2023/052154

§ 371 Date: Sep. 5, 2024

(30) Foreign Application Priority Data
Mar. 8, 2022 (CH) CH000236/2022
Mar. 8, 2022 (FR) FR2201976

(51) Int. Cl. A61C 7/22; A61C 7/18

(52) U.S. Cl. CPC A61C 7/22; A61C 7/18

(57) ABSTRACT

A device for displacement of an upper molar (M) comprising a mesiopalatal cusp, comprising:
a support (12) intended to be fixed to the molar (M),
a rod (14) comprising a first end (14.1) anchored to a palate bone or to at least one tooth adjacent to the molar so that, when the device is in place, the rod has a given position relative to the molar (M),
a rotational hinge (A1) between the support (12) and the rod (14), comprising an axis of rotation (X1) fixed relative to said rod (14) and perpendicular to the occlusal plane, said axis of rotation (X1) being arranged close to the mesiopalatal cusp of the molar (M),
a spring for applying a force to the palatal face of said molar, applying a rotation to said molar (M) about the axis of rotation (X1) so that said molar (M) has a distal rotation.

### TECHNICAL FIELD AND PRIOR ART

The present invention relates to a displacement device in the field of orthodontics, more particularly to an upper molar displacement device.

The aim of the invention is to solve an occlusion problem in the sagittal direction of the upper permanent molars and their anterior teeth.

The upper molar presents the ability to rotate by virtue of its anatomy. Indeed:
It comprises three roots, two vestibular roots and a long palatal root, which forms the axis around which the upper molar pivots.
In addition, the upper molar comprises four cusps, the three most important of which form a triangle, the apex of the triangle being the mesiopalatal cusp, which lies directly above the palatal root.
Furthermore, in a normal occlusion, the mesiopalatal cusp is lodged in the central fossa of the antagonistic lower molar.
The three roots of the upper molar are located in the alveolar bone, which is sandwiched between two dense walls of bone known as the cortical bone, further enhancing its rotation.
Finally, the reduced dimensions of the upper mesial premolar in the palato-vestibular direction tend to transform the mesial translational movement of the upper molar into a mesial rotational movement.
the shape of the upper molar is trapezoidal.

The upper molar tends to present a mesial rotation, that is, forward, when subjected to the stresses of masticatory forces. This rotation plays a natural compensatory role in adapting to an occlusal problem. The inventor discovered that this mesial rotation was an indirect cause of the development of lower incisive crowding. Indeed, the fact that the vestibular cusps are too far forward in the dental arch prevents proper occlusion, which becomes a source of occlusal interference producing force vectors on the lower teeth, ultimately leading to inferior incisive crowding. The inventor described this phenomenon in De Baets, J. and Chiarini, M.: The Pseudo-Class I, a newly defined type of malocclusion, J. Clin. Orthod 29:73-88, 1995, and De Baets, J.: The role of the upper first molar in lower incisor crowding, J. Clin. Orthod. 29: 146 157, 1995.

To make room for the canine and upper incisors, an appliance is usually used which tends to move the upper molar in translation, in order to move it backward. However, it turns out that this movement in translation is not effective in the long term. Indeed, in moving the upper molar in translation, the mesiopalatal cusp withdraws from the fossa of the antagonistic lower molar.

Overtime, this cusp tends to seek its home in the central fossa and thus move forward, and thus becomes an indirect source of the incisive crowding described above.

### PURPOSE OF THE INVENTION

It is therefore, one of the aims of the present application to offer a displacement device allowing an upper molar to be moved efficiently and durably.

The aim stated above is achieved by a displacement device intended to be applied to one of the upper molars configured to apply at least one torque to said upper molar so that it tends to have a distal rotational movement about its palatal root, the axis of rotation of the tooth being fixed by the device. The invention applies primarily to the first upper molar but, can also be applied to the second upper molar.

Indeed, in particular, by applying distal rotation to the first upper molar while fixing the axis of rotation, the trapezoidal shape of the first upper molar when viewed from above, frees up space between the molar and premolar, allowing the canine and incisors to be repositioned.

The inventor has discovered that, in the cases where the mesiopalatal cusp is correctly positioned in its fossa, it is maintained in the fossa during displacement in rotation. Thus, after treatment has been completed, the mesiopalatal cusp no longer tends to advance and reproduce the lower incisive crowding.

In the case where the mesiopalatal cusp is not correctly positioned in its antagonistic fossa; the device simultaneously provides a displacement in rotation and translation to reposition the mesiopalatal cusp in the antagonistic fossa. Thus, even after treatment has been completed, the mesiopalatal cusp no longer tends to move and reproduce incisive crowding.

The orthodontic device is such that it applies a rotation to one of the upper molars about a fixed axis of rotation parallel and close to the natural axis of rotation of said upper molar passing through its palatal root and its mesiopalatal cusp lodged in the antagonist fossa.

The device is intended to be fixed to the upper molar close to its natural axis of rotation, and comprises a fixed axis of rotation, means for applying a force to said upper molar so as to apply a rotational torque to it about the fixed axis of rotation. This force may be applied on the palatal or vestibular side. This force may be exerted, for example, by a tension spring, compression spring, torsion spring or repulsive magnets.

In one embodiment, the device is intended to be anchored on the palatal side either in a palate bone or to a tooth or teeth in the vicinity of said upper molar, for example the premolar and/or a deciduous molar.

In another embodiment, the device is intended to comprise an interdental bone anchor or to be anchored to the zygomatic bone. As a variant, the device comprises a part external to the mouth, which is attached to the skull or nape.

In one embodiment, the device comprises a ring surrounding the molar and securing the upper first molar to the device. In another embodiment, the device comprises a bracket bonded to the molar.

In other words, the device according to the invention has a fixed center of rotation close to the axis of rotation of the molar, allowing the mesiopalatal cusp to be held in the antagonistic fossa. The force generating the rotation can be applied on the vestibular or palatal side.

The axis of rotation may be subjected to simultaneous distal rotation and distal or mesial translation, allowing the mesiopalatal cusp to be relodged in the fossa.

Some embodiments present the advantage of not requiring patient collaboration.

One of the subject-matters of the present application is therefore a device for displacement of an upper molar comprising a mesiopalatal cusp, comprising:
a support intended to be attached to the upper molar,
a rod comprising a first end intended to be anchored to a palate bone or to at least one tooth adjacent to the upper molar so that, when the device is in place, the rod has a given position relative to the upper molar,
a rotational hinge between the support and the rod, said rotational hinge comprising an axis of rotation intended to be fixed relative to said rod and to be perpendicular to the occlusal plane, said axis of rotation being intended to be arranged close to the mesiopalatal cusp of the upper molar,
and means configured to apply a force able to rotate said upper molar about the axis of rotation, so that said upper molar rotates distally, said force being applied either to the palatal face of the molar or to a vestibular face of the molar.

In one example embodiment, the rod comprises a pin intended to form the axis of rotation and the support comprises a housing for said pin, or the support comprises a pin intended to form the axis of rotation and the rod carries a housing for said pin, the pin and housing assembly forming the rotational hinge.

In one embodiment, the means configured to apply a force to the palatal face of the molar able to apply a rotation to said upper molar comprises at least one torsion spring comprising coils and two radially extending strands, said coils being mounted on the pin, one strand being fixed to the support and the other strand being fixed to the rod, the attachment of the other strand to the rod causing the spring to be loaded.

The housing can comprise a lateral opening over its height, allowing the coils to be positioned by transverse displacement of the spring, said housing comprising a transverse slot for the passage of the strand fixed to the support.

In another embodiment, the means configured to apply a force to the palatal face of the molar able to apply a rotation to said upper molar comprise a tension spring intended to be fixed by a first end intended for a palate bone or neighboring tooth or teeth and is fixed to the support at a location distinct from that of the pivot hinge.

In another embodiment, the means configured to apply a force on the palatal face of the molar able to apply a rotation to said upper molar comprises a tension spring mounted about the rod, fixed by a first end to the rod on the side of its first end, the device also comprising a bar, one end of which slides along the rod and one end of which is fixed to the support at a location distinct from that of the pivot hinge, the second end of the spring being fixed to the end of the bar sliding on the rod.

In another embodiment, the means configured to apply a force on the vestibular face of the molar able to apply a rotation to said upper molar comprises a part articulated in rotation on the support, said part being located on the vestibular face of the molar and elastic means or repulsive magnets exerting a force on said articulated part. The means configured to apply force to the vestibular face of the molar can be configured to be anchored between two teeth or to the zygomatic bone or can be extraoral and fixed to the patient's skull or nape.

The displacement device may also comprise means configured to apply a force able to move in translation said upper molar.

The means configured to apply a force able to move in translation said upper molar may comprise a compression spring or magnets oriented relative to one another so as to repel one another.

For example, the rod comprises a first part and a second part configured to slide relative to each other and the compression spring is mounted on the rod in reaction between the first part and the second part, or the magnets are mounted on the first part and the second part.

Very advantageously, the first part and the second part have cross sections such that they prevent a relative rotation about their axis.

The support is a ring intended to be mounted about the first upper molar and/or wherein the displacement device comprises a bracket fixed to a tooth or teeth adjacent to the first upper molar, to which the first end of the rod is fixed.

### BRIEF DESCRIPTION OF THE FIGURES

The following description will be better understood with the aid of the appended drawings:

FIG. 1 is a partial schematic representation of the upper jaw dentition,

FIG. 2 is a view from below of an example of a palatal displacement device according to a first embodiment, the spring being in an activated state,

FIG. 3 is a detailed view of FIG. 2,

FIG. 4 shows schematic representations of torsion springs for use in the present invention,

FIG. 5 is a representation of the displacement device in FIG. 2, the spring being in a deactivated state,

FIG. 6 is a perspective view of another example of a palatal displacement device according to the first embodiment (the spring not being shown),

FIG. 7 is a plan view of another example of a palatal displacement device according to the first embodiment,

FIG. 8A is a perspective view of another example of a palatal displacement device according to the first embodiment,

FIG. 8B is an enlarged view of the housing implemented by the device in FIG. 8A,

FIG. 9 is a perspective view of another example of a palatal displacement device according to the first embodiment,

FIG. 10 is a perspective view of an example of a palatal displacement device according to a second embodiment,

FIG. 11A is a perspective view of an example of a palatal displacement device according to a third embodiment,

FIG. 11B is a schematic representation of the cross sections of the rod and sleeve of the device in FIG. 11A,

FIG. 12 is a perspective view of another example of a palatal displacement device according to a third embodiment,

FIG. 13 is a plan view of another example of a palatal displacement device according to a third embodiment,

FIG. 14A is a plan view of another example of a palatal displacement device according to a third embodiment,

FIG. 14B is a plan view of one variant of the device in FIG. 14A,

FIG. 15 is a plan view of another example of a palatal displacement device according to a third embodiment,

FIG. 16A is a schematic representation of another example of a palatal displacement device according to the second embodiment before and after distal rotation,

FIG. 16B is a schematic representation of the palatal displacement device of FIG. 16A after distal rotation,

FIG. 17 is a view from above of another example of a torsion spring adapted for application in a palatal displacement device,

FIG. 18 is a schematic representation of an example of a vestibular displacement device,

FIG. 19 is a schematic representation of an example of a part of the means allowing to exert a rotational force adapted to the vestibular displacement device,

FIG. 20A is a schematic representation of an example of another part of the means allowing to exert a rotational force adapted to the vestibular displacement device,

FIG. 20B is a schematic representation of one variant of the means allowing to exert a rotational force adapted to the vestibular displacement device,

FIG. 20C is a schematic representation of another variant of the means allowing to exert a rotational force adapted to the vestibular displacement device,

FIG. 21 is a schematic representation of another example of a vestibular displacement device,

FIG. 22 is a schematic representation of an example of a vestibular displacement device,

FIG. 23A is a schematic representation of an example of a vestibular displacement device,

FIG. 23B is a schematic representation of one variant of the device shown in FIG. 23A,

FIG. 24A is a perspective view of another example of a displacement device according to the third embodiment,

FIG. 24B is a cross sectional view of one variant of the device in FIG. 24A,

FIG. 25A is a perspective view of another example of a displacement device according to the third embodiment shown in transparency,

FIG. 25B is a representation of the device of FIG. 25A in a disassembled state.

### DETAILED DESCRIPTION OF EMBODIMENT

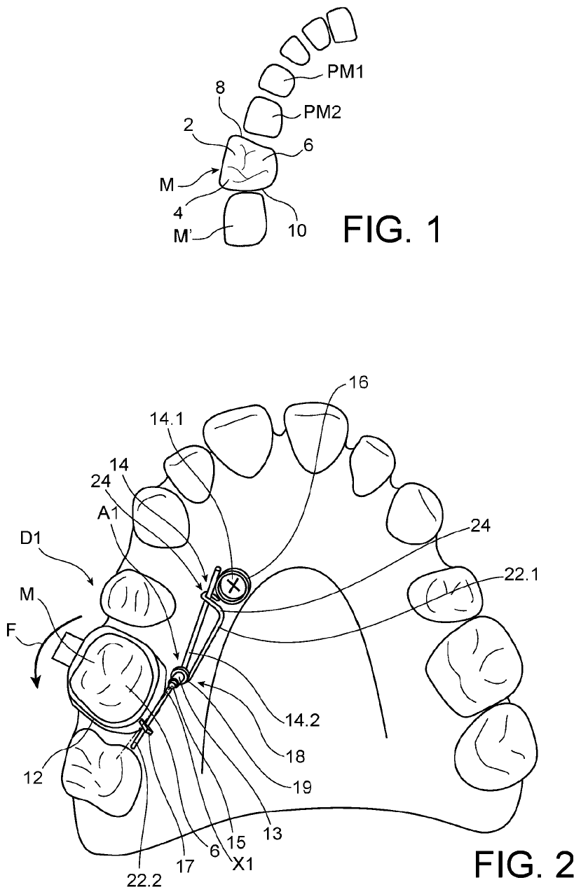

In FIG. 1 can be seen a schematic diagram partially representing an upper jaw dentition seen from below, allowing to define the various terms used in the description.

The invention is intended to exert at least one rotational force on one of the upper molars and is particularly suited to applying a rotational force to the first molar. The following description relates to the application of the device to the first upper molar, which will be referred to as “upper molar” or “molar” as appropriate. However, the invention can be applied to both the first upper molar and the second upper molar.

The invention relates to a displacement device which is configured to apply a force on the palatal side of the molar, which will be referred to as a “palatal displacement device”, and to a displacement device which is configured to apply a force on the vestibular side of the molar, which will be referred to as a “vestibular displacement device”.

Reference M designates the first upper molar, M′ designates the second upper molar, PM1 and PM2 designate the premolars, PM2 being the mesial premolar.

Reference 2 designates the mesiovestibular cusp, reference 4 designates the distovestibular cusp and reference 6 designates the mesiopalatal cusp.

Reference 8 refers to the mesial (front) part of the molar M and reference 10 to the distal (rear) part of the molar. The vestibular face of the molar is the outer face, and the palatal face is the inner face.

The terms “front” and “back” are considered in relation to the incisors, with the front oriented toward the incisors and the back oriented away from the incisors.

In a Class I occlusion, which is the reference position, the mesiopalatal cusp of the first upper molar is lodged in the central fossa of the antagonistic molar.

In FIG. 2 can be seen an example of a palatal displacement device D1 according to a first embodiment seen from below.

The device D1 comprises a ring 12 configured to be placed around the molar M and form a hoop. The ring 12 is bonded to the molar M, for example, so that the molar M and the ring 12 are secured together in movement. A tubular housing 13 with an axis perpendicular to the occlusal plane is fixed to the inner lateral or to the palatal face of the ring 12. The tubular housing 13 is positioned on the ring 12 so that, once in place on the molar, it is close to the mesiopalatal cusp.

The device also comprises an element 14 intended to be fixed in the mouth of the patient, referred to as “fixed element 14”, formed by a rod, a first end 14.1 of which is intended to be anchored in a palate bone; this is a bone anchor. To this end, the first end 14.1 comprises a loop which receives a screw 16 screwed into the palate. The second end 14.2 of the rod 14 forms a pin 15 configured to lodge in the tubular housing 13. The rod 14 is intended to be immobile relative to the palate.

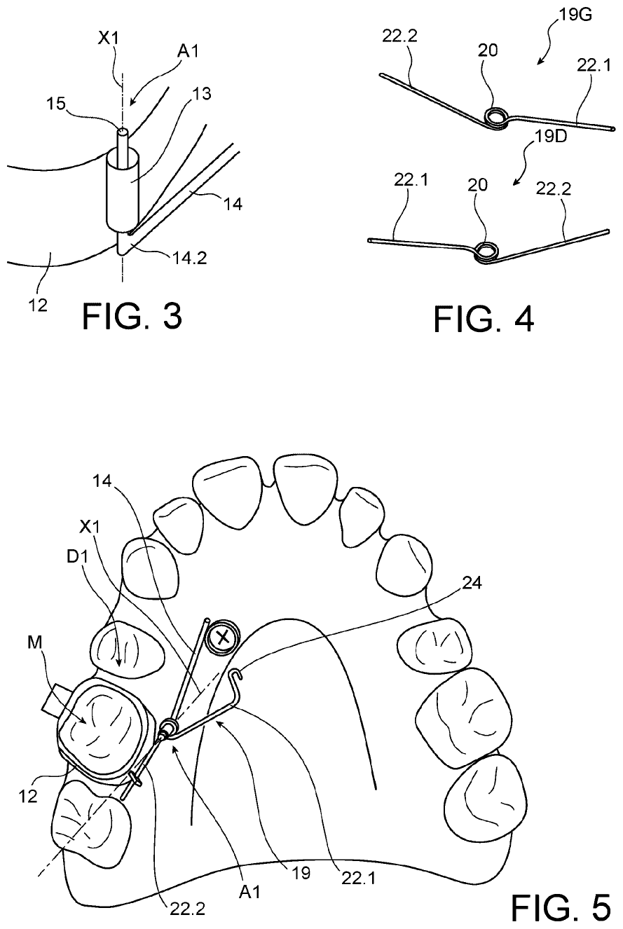

The pin 15 and the tubular housing 13 form a pivot hinge A1 with a fixed axis of rotation X1. This axis of rotation X1 is substantially parallel to the natural axis of rotation of the molar, which passes through the palatal root and the mesiopalatal cusp lodged in the antagonistic fossa. The axis X1 of the hinge A1 is located as close as possible to the natural axis of rotation of the molar. In FIG. 3 can be seen an enlarged view of the rotational pivot hinge A1.

The device D1 also comprises the means 18 configured to exert a force on the molar so that it has a distal rotational movement.

By “distal rotational movement” is meant a rotational movement in which the vestibular face of the molar tends to move toward the rear of the jaw about the axis of rotation of the molar, as indicated by the arrow F.

The means 18 comprises a torsion spring 19.

In FIG. 4 can be seen a spring 19G intended to act on the left molar and a spring 19D intended to act on the right molar. The torsion spring comprises coils 20 and two radially extending strands 22.1, 22.2. The coils 20 tend to return the strands 22.1, 22.2 to a rest position. Preferably, the torsion spring is mounted on the ring 12, the coils 20 being lodged in the tubular housing 13 and a free end of the strand 22.2 is received in a sleeve 17 attached to the inside lateral face of the ring 12. In the example shown, the strand 22.2 is straight.

As can be seen from FIG. 2, the inside diameter of the coils is sufficient to be mounted about the tubular housing, and the pin is inserted into the tubular housing. The device comprises means for loading the spring. In this example, this means is formed by a hook 24 provided at the free end of the strand 22.1 oriented to the side of the bone anchor and intended to be attached to the rod 14.

When the device D1 is placed on the molar, the strand 22.1 pivots and the hook 24 is attached to the rod 14 (FIG. 2). In FIG. 5, the strand 22.1 is not hooked onto the rod 14, so the spring is not activated.

The operation of the device D1 will now be described.

In FIG. 5 can be seen a schematic representation of the action of the device D1 on the molar M.

In FIG. 5 the torsion spring 19 exerts force on the ring 12 in a counterclockwise direction, which is itself guided in rotation about the axis X1 of the fixed pivot hinge A1.

The ring 12 being secured in rotation to the molar M, the molar M is driven in rotation in the distal direction, which in this case corresponds to an anticlockwise rotation. Due to the fixed axis of rotation X1, the mesiopalatal cusp is held in position in the fossa.

The molar having a trapezoidal shape, this distal rotation movement frees up space between the molar and the premolar. This space then allows to act on the canine and incisors by repositioning in the desired position.

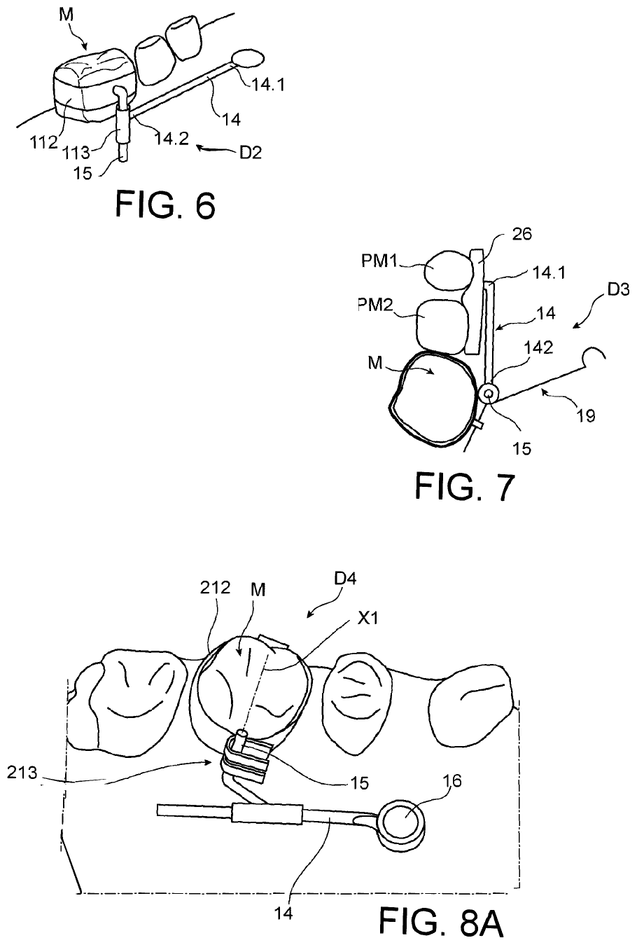

In FIG. 6 can be seen a palatal displacement device D2 according to one variant, in which the tubular housing 113 is fixed to the second end 14.2 of the rod 14 and the pin 15 is fixed to the inner lateral face of the ring 112. In this variant, the housing 113 is received in the coils of the torsion spring (not shown).

According to another example embodiment of a palatal displacement device shown in FIG. 7, the device D3 is not anchored in the palate bone, but on adjacent teeth, for example, the first PM1 and second PM2 premolars or a deciduous molar. In this example, the device comprises a bracket 26 shaped to be fixed to the palatal surface of the PM1 and PM2 premolars. The rod 14 is fixed by its first end 14.1 to the bracket 26. The rest of the device is similar to that of the device D1.

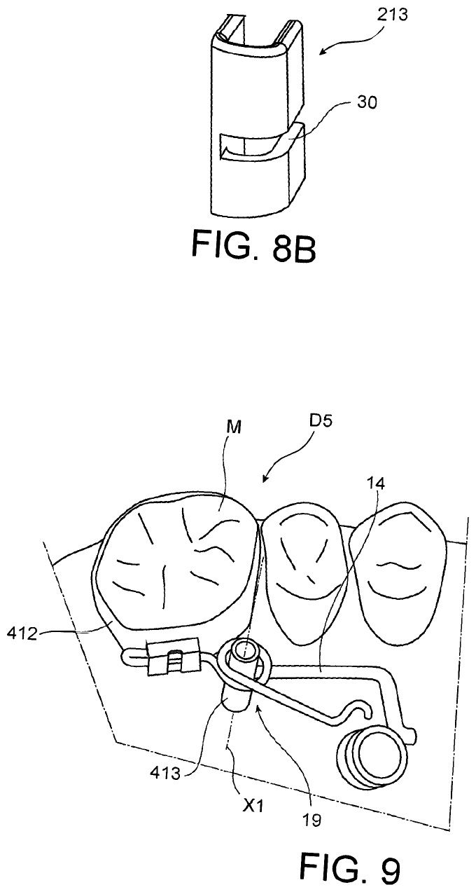

In FIGS. 8A and 8B, can be seen a palatal displacement device D4 according to another variant embodiment, in which the housing 213 is vertically open allowing the coils of the torsion spring (not shown) to be inserted, the housing 213 forms a sort of cradle for the pin 15 and the coils. In addition, the wall of the housing is provided with a transverse slot 30 for the passage of the torsion spring strand 22.2. This variant embodiment allows to facilitate the mounting of the pin and the spring.

The ring 212 provided with the open housing 213 can advantageously be produced by additive manufacturing, also referred to as “3D printing”.

In FIG. 9 can be seen a palatal displacement device D5 according to the first embodiment, in which the axis of rotation X1 of the rotational hinge is not directly on the inner face of the ring 412 but is offset. In this example, the housing 413 is rigidly connected to the fixed element 14. The axis of rotation X1 nevertheless remains close to the ring and to the side of the mesiopalatal cusp, and therefore to the natural axis of rotation of the molar. The coils of the spring 19 are mounted about the housing 413. This embodiment presents the advantage that it gives the mesiopalatal cusp more freedom when subjected to masticatory forces.

In FIG. 10 can be seen an example of a palatal displacement device D6 according to a second embodiment, in which the means for exerting a rotational force on the molar comprises a tension spring 27 fixed by a first end 27.1 to the rod 14 on the side of the first end 14.1 and by a second end 27.2 to an angled bar 28 fixed to the inner lateral face of the ring 12 in a position set back relative to the housing 13.

The tension spring 27 comprises, for example, a loop at each end, which is mounted on a projection of the rod 14 and on the bar 28.

The spring 27 exerts a tensile force on the angled bar 28, which moves the ring 12 in the clockwise direction shown in FIG. 10 (symbolized by the arrow), which in turn is guided in rotation about the axis X1 of the pivot hinge A1, which is fixed.

In certain situations, it may be desirable to apply a force simultaneously with the application of a rotational force to the molar, to apply a force so as to move the molar in translation to replace the mesiopalatal cusp in the antagonistic fossa. In the examples of the third embodiment described below, the orthodontic device allows both distal rotation of the molar and displacement in translation of the molar, which may be backward (distal translation or distalization) or forward (mesial translation or mesialization).

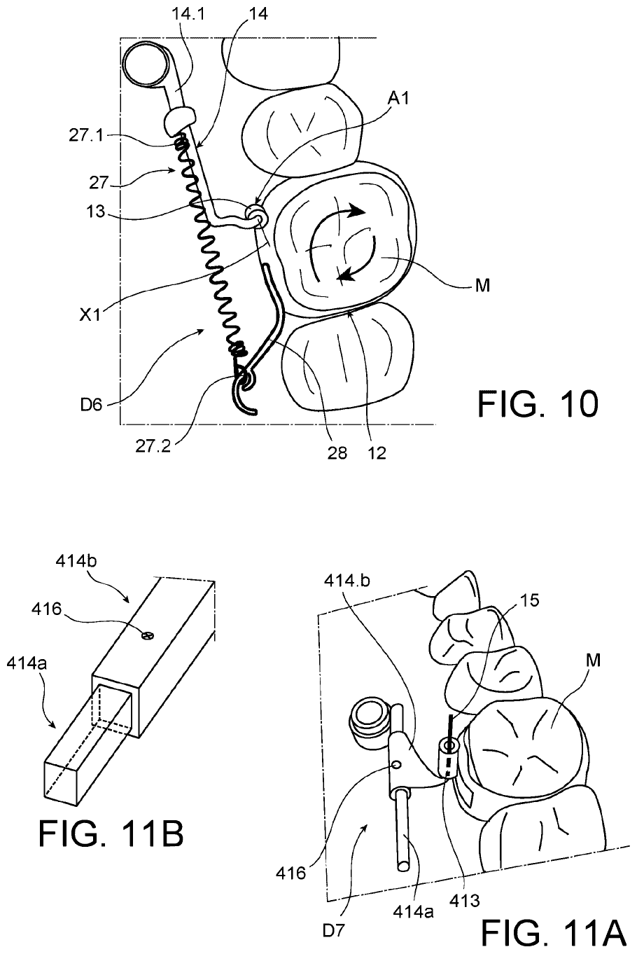

In FIG. 11A can be seen an example of a palatal displacement device D7 according to a third embodiment able to apply both a rotational force to the molar and a translational force.

The device D7 is similar to the device D1 with regards to the means for rotating the molar.

In this example, the device D7 comprises a fixed element 414 comprising a rod 414a, anchored by one end, to the palate and a sleeve 414.b slidably mounted on the rod 414.a. The sleeve 414.b carries the pin 15, which is received in the housing 413 which is attached to the ring. Translation is activated by a tension or compression spring (not shown) mounted on the rod 414.a., which acts on the sleeve 414.b. Means are provided to stop the movement in translation, for example a screw 16 passing through the sleeve 414.b. The length of rod 414.a can be modified during treatment or can be permanently fixed during treatment.

As shown schematically in FIG. 11B, it is highly advantageous that the sleeve 414.b and the rod 414.a have cross-sections such that they prevent relative displacement in rotation about their axis, which allows the pin 15 to be held perpendicular to the occlusal plane. For example, the sleeve 414.b and first portion 414.a have a rectangular cross-section. A screw 416 immobilizes the two parts in translation.

In this example, the torsion spring is not shown.

It will be understood that other shapes of the various parts are conceivable. In addition, the housing can be carried by the second part and the pin by the ring.

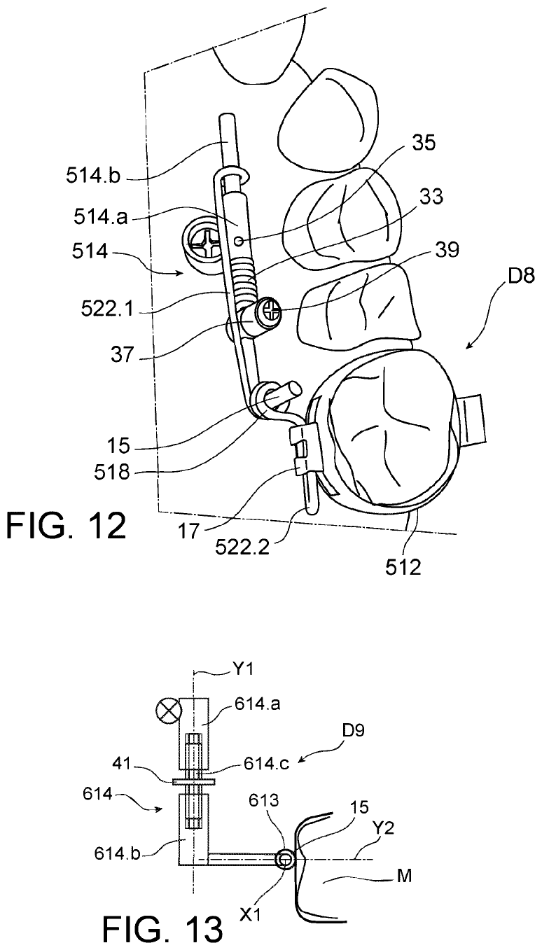

In FIG. 12 can be seen another example of the palatal displacement device D8 according to the third embodiment.

In this example, the device D8 comprises a ring 512 provided with a sleeve 17 on the outer face of the ring 512 oriented perpendicular to the axis of the ring, also parallel to the occlusal plane, and receiving a strand of the torsion spring.

The device D8 comprises a torsion spring 518 the coils of which are mounted about the pin 15, one strand 522.2 is slid into the sleeve 17 of the ring 512 and the other strand 522.1, which serves to activate the spring, comprises a hook which hooks onto the fixed element 514, loading the spring. The coils of the spring 518 are mounted about the pin 15, which is part of the rod 514.

The fixed element 514 comprises a first part 514.a, which is a sleeve intended to be anchored to a palate bone, and a second part 514.b formed by a rod carrying the pin 15 and sliding in the first part 514.b. A screw 35 allows to secure the rod 514.b in the sleeve 514.a.

A translation spring 33 is mounted between the first part 514.a and the second part 514.b and can exert either a compressive or a tensile force. The spring is intended to exert a compressive or tensile force to move the tooth in either distal or mesial translation respectively.

In the remainder of the description, the spring intended to move the tooth in translation will be referred to as a “translation spring”, whether acting in compression or tension.

In addition, the device D8 comprises means for activating the spring 33 in compression or tension and fixing its load. In this example, these means comprise a slide 37 slidably mounted on the rod 514.b between the molar M and the fixed sleeve 514.a. The translation spring 33 pushes on the slide 37, which is fixed to the rod 514.b, and causes the rod 514.b to slide, resulting in a distal movement in translation of the pin 15.

The slide 37 comprises a screw 39 to secure it axially to the second part 514.b, defining a load level for the spring 33.

Preferably, as with the device D7, the first part 514.a and the second part 514.b are such that they are fixed in rotation relative to each other, for example they have a square or rectangular cross-section.

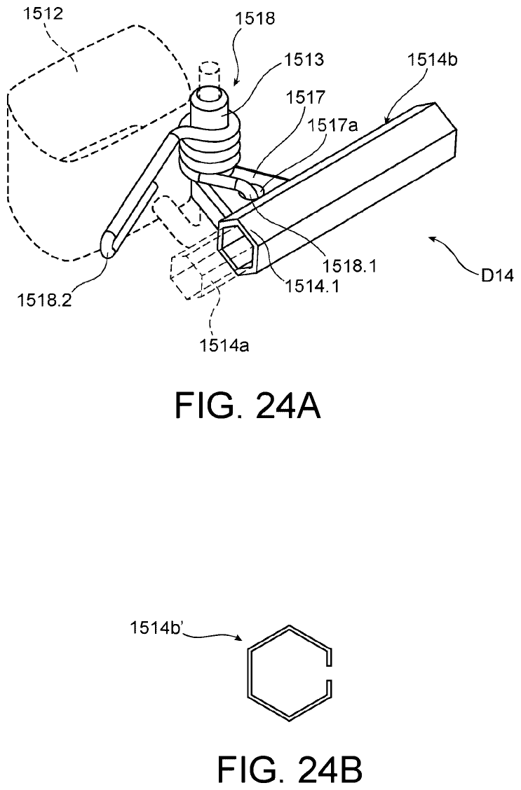

In FIG. 24A can be seen a further example of a palatal displacement device D14 according to the third embodiment.

On the one hand, in this example, the tubular housing 1513 is fixed to the second end 1514.1 of a sleeve 1514b, slidably mounted on a rod 1514a (shown in dotted line) fixed to the palate, and the pin 1515 is fixed to the inner lateral face of the ring 1512 (also shown in dotted line). The housing 1513 is connected to the sleeve 1514b by a base 1517 which has a hole 1517a intended to receive a strand 1518.1 of the torsion spring 1518. The coils of the torsion spring are mounted about the tubular housing 1513. The other strand 1518.2 is intended to cooperate with the crown to activate the spring.

As a variant, and similarly to the device D5, the pivot hinge is not directly on the inner face of ring 1512 but is offset. In this example, the pin forming the axis of rotation is fixed to the end of the fixed element 14. The axis of rotation X1 is in front of the sleeve receiving one end of the torsion spring and remains close to the ring and to the side of the mesiopalatal cusp, and therefore to the natural axis of rotation of the molar. The coils of the spring 19 are mounted about the pin, and the device acts on the molar via the end of the spring received in the sleeve. This embodiment presents the advantage of leaving the mesiopalatal cusp more freedom when subjected to masticatory forces.

Advantageously, the sleeve 1514b has a polygonal inner cross-section and the rod 1514a has a polygonal cross-section, preventing rotation of the tube about the rod 1514a.

On the other hand, similarly to the device D8, the device D14 comprises a translation spring (not shown) and means for loading the translation spring (not shown). For example, the translation spring can be a rubber band stretched between the pin and the tooth and exerting a mesial force.

The device D14 presents the advantage of being of simplified construction.

As a variant, the sleeve 1514b′ is not completely closed on itself, as shown in FIG. 24B, its shape is such that it ensures guidance in translation along the rod.

In one example, the housing 1513 and the sleeve 1514b are 3D printed.

The device D14 may not comprise a translation spring for exerting compression or traction and may be intended solely to apply distal rotation in a manner similar to the device D5.

In another example, the housing 1513 is made by 3D printing or by machining and the sleeve is made by machining or bending and is welded to the housing.

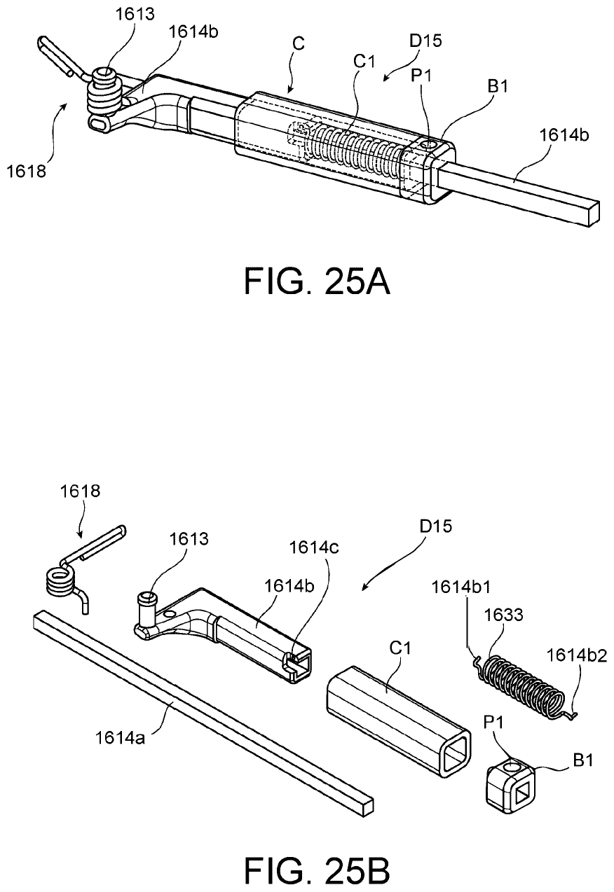

In FIG. 25A can be seen another example embodiment of a device D15 according to the third particularly advantageous embodiment, since it can be used to apply both distal rotation and distalization, or both mesial rotation and mesialization.

In FIG. 25B can be seen a view of the device in a disassembled state.

The device D15 also presents the advantage of presenting a shroud that protects the translation spring, making the device particularly easy to install and maintain.

The device D15 comprises a sleeve 1614b of similar shape to that of the device D14 and a pin 1615 fixed to the end of the sleeve 1614b and forming the axis of rotation. The torsion spring 1618 is mounted about the pin 1615. The device D15 acts on the molar by means of the strand 1618.1 of the torsion spring 1618, which is received in a sleeve secured with the outer face of the ring mounted on the molar.

As a variant, the pin 1615 is hollow and forms a housing for a pin secured with the ring in a similar way to the device D14.

In this example, the sleeve 14614b is square in cross-section, as well as the rod 1614a. As a variant, any other polygonal shape can be used.

The device D15 comprises a translation spring 1633 and a shroud C which covers the translation spring and part of the sleeve 1614b. In this example, the shroud C is in two parts, comprising a sleeve C1 and a plug B1, which are secured together, for example by welding.

The translation spring is fixed by a first end to the sleeve 1614b and by a second end to the rod 1614a. In the example shown, the spring 1614b comprises at its first end a curved strand 1614b.1 received in a hole 1614c made in a cut-out in the sleeve 1614b, and at its second end a curved strand 1614b.2 received in a hole made in the shroud, more particularly in the plug B1. The shroud is fixed to the rod by a screw (not shown). In the example shown in FIGS. 25A and 25B, the plug B1 comprises a hole P1 receiving the screw (not shown) intended to immobilize the shroud relative to the rod.

Adjustment of the translation spring load and its action in translation or in tension is achieved simply by sliding the shroud over the rod 1614a and in fixing it by means of the screw.

The positioning of the device D15 in the mouth of the patient will now be described.

The rod 1614a has first been fixed to the palate. The device D15, which has been pre-assembled, is mounted about the rod 1614a, which enters the translation spring 1633 and the sleeve 1614b, and the pin 1615, which is secured with the crown, is inserted into the housing 1613.

The free strand of the torsion spring 1615 is slid into the sleeve provided on the crown, similar to the sleeve seen in FIG. 9.

The screw is then inserted into the hole P1 in the plug B1 to fix the action of the translation spring in tension or compression and adjust its load. Indeed, when the shroud is brought closer to the sleeve, the spring is compressed; when the shroud is moved away from the sleeve and stretches the translation spring, which is fixed to the sleeve and the shroud, it is tensioned.

Installation and adjustment of this device are thus considerably simplified.

The translation spring 1633 being fully shrouded, the device is easy to handle and maintain. In addition, the device presents an improved visual appearance.

In FIG. 13 can be seen an example of a palatal displacement device D9 according to the third embodiment, in which the device comprises a first part extending according to a first axis Y1 and a second part extending according to a second axis Y2 perpendicular to the axis Y1.

In this example, the housing 613 is carried by the ring and the pin 15 is carried by the fixed element 614. The fixed element 614 is telescopic.

In this example, the rod 614 comprises a first part 614.a anchored to the palate, a second part 614.b carrying the pin and a third part 614.c formed by a threaded rod onto which the first and second parts are screwed. A knurled wheel 41 is secured in rotation with the threaded rod 614.c and is arranged between the first and second parts. By turning the knurled wheel, the threaded rod 614.c turns, causing the first and second parts, which are fixed in rotation, to move apart or toward each other. The device also comprises a means (not shown) for preventing relative rotation of the parts 614.a and 614.b. This means comprises, for example, two bars parallel to the axis Y1 and arranged on either side of the rod 614. The bars are fixed by one end to the first part 614.a and by the other end to the second part 614.b. The two bars anchored to the parts 614.a and 614.b immobilize parts 614.a and 614.b in rotation relative to each other.

The adjustment system can be replaced by any other device well known to the person skilled in the art, such as the device sold under the trademark Variety SP Maxi© by the Dentaurum® company. Other adjustment devices are also manufactured by Leone and Rocky Mountain®. These devices use a key to change the setting.

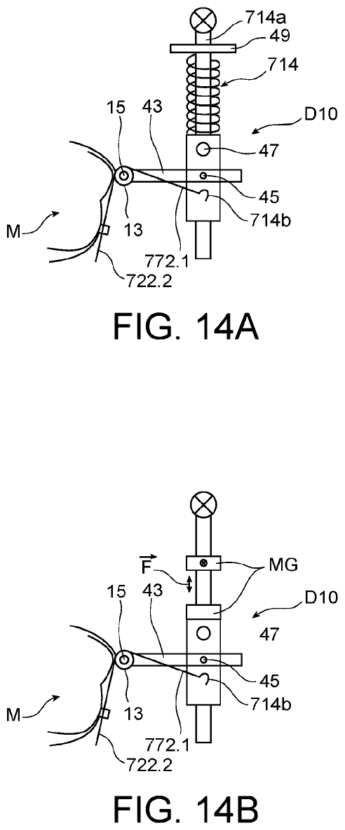

In FIG. 14A can be seen another example of a palatal displacement device D10 according to the third embodiment, comprising a telescopic fixed element 714 comprising a first part 714.a formed by a rod intended to be anchored to a palate bone, and a second part 714.b formed by a sleeve rigidly carrying the hinge pin. In this example, the pin is not aligned with the axis of the rod, a bar 43 is fixed to the sleeve 714.b transversely thereto, the free end of the bar 43 carrying the pin 15. In this example, the 43 is fixed to the rod by a screw 45, which allows adjustment of the bar 43 relative to the housing that receives the pin, and also serves to hook the strand 722.1 of the torsion spring 719 to ensure its activation.

The first part 714.a comprises a first portion slidably mounted in the sleeve 714.b. Preferably, the first part 714.a and the sleeve 714.b have rectangular or square cross-sections, or more generally a cross-section preventing their relative rotation about their axes. A screw 47 passing through the sleeve 714.b clamps the first portion and ensures their relative immobilization.

The portion of the first part which does not slide into the second part is circular in cross-section and is threaded and has a knurled wheel 49 mounted on it. A compression spring is fitted about the threaded portion between the knurled wheel 49 and the second part. The displacement of the wheel allows the action and load of the translation spring to be varied.

In FIG. 14B can be seen a variant embodiment of the device D10 in which the compression spring is replaced by two magnets MG oriented relative to one another so that they repel one another.

It should be noted that in the device D8 of FIG. 12, the spring 33 could be replaced by two magnets oriented relative to each other so that they repel or attract one another depending on the action desired; for example, one magnet would be carried by the first part 514a and the other would be carried by the slide 37.

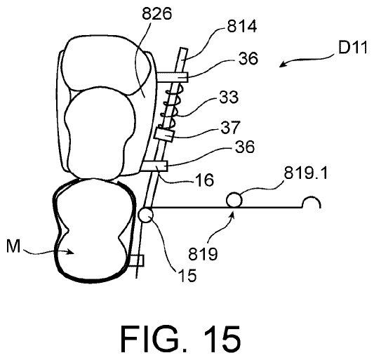

In FIG. 15 can be seen another example of a palatal displacement device D11 according to the third embodiment, in which the device is anchored to adjacent teeth.

In this example, the bracket 826 fixed to the adjacent teeth has two fixed collar-type supports 36 aligned so as to fix the direction of the rod 814 and in which the rod 814 slides. The rod 814 carries the pin 15.

Means are provided to ensure axial immobilization of the rod 814, for example, a screw 16 passing through one or both collars.

The device comprises a translation spring 33 mounted on the rod 814.

In addition, the device D11 comprises means for loading the translation spring 33. In this example, the rod 814 comprises a slide 37 slidably mounted between the two collars. The translation spring 33 pushes on the slide 37, which is fixed to the rod 814 and will cause the rod 814 to slide, causing a distal or mesial movement in translation of the pin 15 which is received in the support.

In FIG. 15, the torsion spring 819 is deactivated. Also, in this example, the torsion spring 819 comprises a loop 819.1 on one of its strands. The implementation of such a spring in orthodontic devices according to the invention further improves their effectiveness, that is, reduces the parasitic effect on neighboring teeth. This spring can be implemented in any device comprising a torsion spring.

Preferably, at least one of the two parts has a rectangular or square cross-section to prevent a relative rotation of the two parts about their axis.

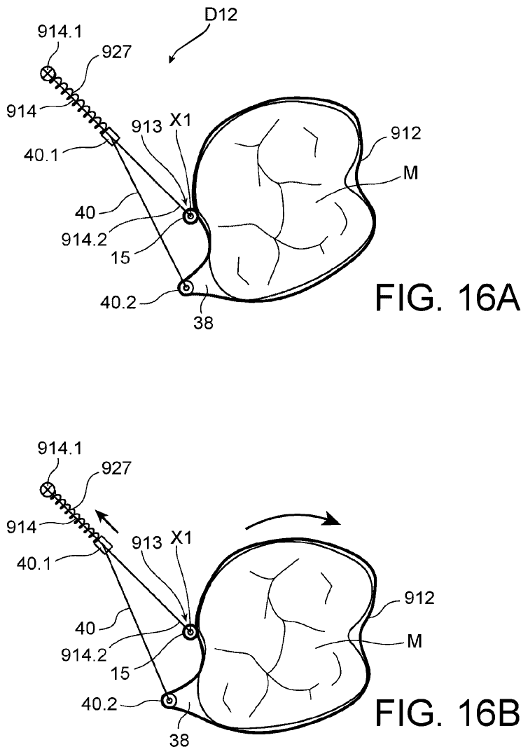

In FIGS. 16A and 16B can be seen a palatal displacement device D12 according to the second embodiment, in which the rotational force is obtained by a movement in translation.

In this example, the ring 912 comprises a housing 913 receiving the pin 15 which fixes the axis of rotation. It also comprises an element 38 for fixing a rod 40 intended to exert a tensile force.

The device comprises a fixed element 914 formed by a rod intended to be anchored to the palate by a first end 914.1 and carrying the pin 15 at the second end 914.2.

The device also comprises a rod 40 comprising a first end 40.1 slidably mounted on the fixed rod and a second end 40.2 articulated on the element 38. For example, the first end 40.1 of the rod 40 comprises a slide which slides about the rod 914. The device also comprises a tension spring 927 mounted on the fixed rod 914 and fixed to the slide of the articulated rod 40, and exerting a tensile force on the first end 40.1 of the articulated rod 40.

FIGS. 16A and 16B illustrate the action of the device on the molar. The articulated rod 40 exerts traction on the molar at the element 38, which pivots distally about the fixed axis of rotation X1.

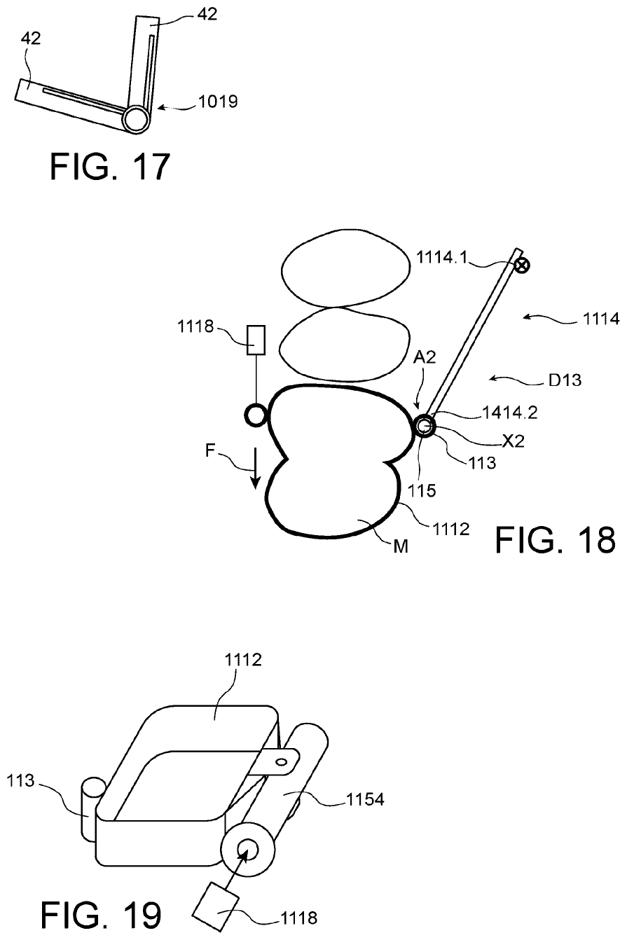

In FIG. 17 can be seen another example of a torsion spring 1019 to which are associated the caps 42 covering the strands of the spring on one side. The other side of the spring is left free to allow insertion of the pin into the coils and hooking of the strands of the spring onto the ring and the rod. Preferably, the spring is supplied with the caps and mounted in the device.

Vestibular displacement devices will now be described.

The vestibular displacement device is configured to apply a distalizating force to the molar on the vestibular side that causes a distal rotation, and to center the mesiopalatal cusp in the central fossa of the antagonist.

In FIG. 18 can be seen a schematic representation of a vestibular displacement device D13.

The device D13 comprises a ring 1112 secured to the first molar, for example bonded to the molar M, so that the molar M and the ring 1112 are secured together in movement. A tubular housing 113 with an axis perpendicularto the occlusal plane is fixed to the inner lateral or palatal face of the ring 1112. The tubular housing 113 is positioned on the ring 1112 so that, once in place on the molar, it is close to the mesiopalatal cusp.

The device also comprises an element 1114 intended to be fixed in the mouth of the patient, referred to as the “fixed element”, formed by a rod, a first end 1114.1 of which is intended to be anchored in the palatine bone; this is a bone anchor. For this purpose, the first end 1114.1 comprises a loop that receives a screw, screwed into the palate. The second end 1114.2 of the rod 1114 forms a pin 115 configured to be lodged in the tubular housing 113.

The rod 1114 is intended to be immobile relative to the palate. The pin 115 and the tubular housing 113 form a hinge A2 with a fixed axis of rotation X2. This axis of rotation X2 is substantially parallel to the natural axis of rotation of the molar, which passes through the palatal root and the mesiopalatal cusp lodged in the antagonistic fossa. The axis X2 of the hinge A2 is located as close as possible to the natural axis of rotation of the molar.

The device D13 also comprises the means 1118 configured to exert a force F on the molar on the vestibular side so that it has a distal rotational movement.

In this example, the ring may be similar to the ring described in EP0689403B1 and in the document De Baets, J.: Interception of the Pseudo-Class I using the rotational headgear tube, J. Clin. Orthod. 29: 244-256, 1995 and shown in FIG. 19.

On its vestibular side, the ring comprises a portion 1154 movably mounted in rotation relative to the ring 1112 about an axis perpendicular to the occlusal plane. The means 1118 for exerting the distal force are fixed to the part 1154, so as to apply a distal force to the molar on which the ring will be mounted. This distal force is transmitted to the molar, which pivots backward. The part 1154 and/or the ring 1112 are shaped so that the force exerted by the means 1118 remains substantially the same during the displacement in rotation of the tooth.

The means 1118 may be extra-oral. Traction is exerted by elastic bands attached to the skull or nape of the patient.

The means 1118 can be intra-oral. It may comprise springs or elastics which are fixed by one end to an interdental bone anchor or an anchor in the zygomatic bone and another end fixed to the moving portion 1154.

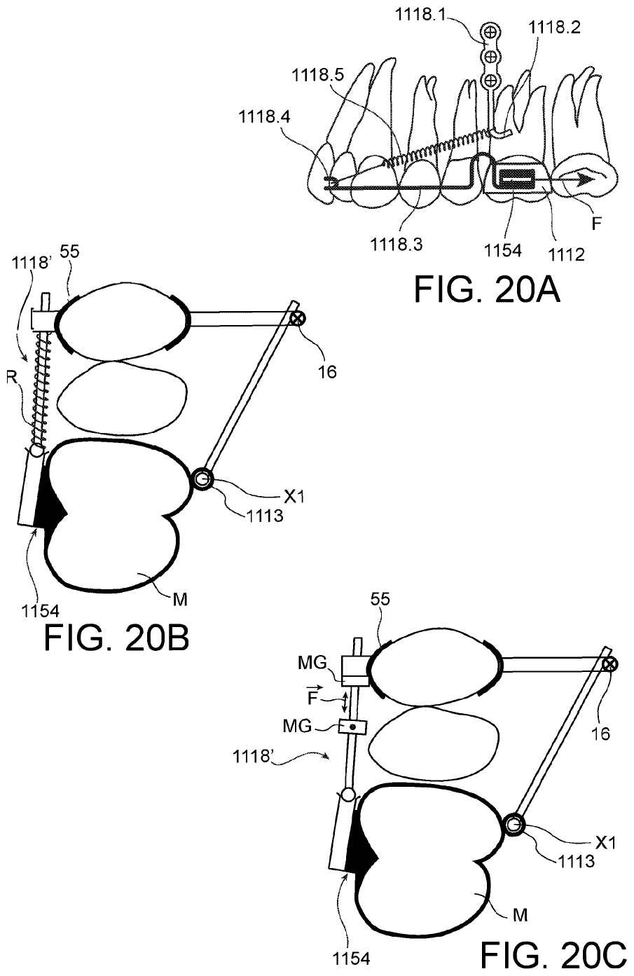

In FIG. 20A can be seen a schematic representation of an intra-oral means 1118 with zygomatic anchorage. The means comprises a bracket 1118.1 fixed to the zygomatic bone and fitted with a hook 1118.2, and a rod 1118.3 mounted by one end in the moving portion 1154 and fitted at the other end with a hook 1118.4. The means 1118 also comprises a spring 1118.5 mounted in tension between the hook 1118.2 and the hook 1118.3. The tensile force exerted by the spring 1118.5 is converted into a distal thrust force.

In FIG. 20B can be seen a variant embodiment in which the means 1118′ applies a thrust force directly. For example, the means 1118′ comprises a bar and a compression spring R or a piston. The bar is slidably mounted relative to a bracket 55 which is bonded to one or more premolars or a deciduous molar or by a fixed screw mounted between the premolars, for example, and is able to be fixed to the bracket. The bar comprises a spherical end, which enters a tube secured with the ring, the axis of which is oriented outward and is parallel to the occlusal plane so that, as the sphere enters the tube, the molar is forced to rotate. An annular linear connection is provided between the rod and the ring. The device also comprises a bar between the anchor 16 and the bracket 55 fixed to the premolar, immobilizing the premolar and avoiding the parasitic effect of the reaction force of the spring.

According to one variant shown in FIG. 20C, the thrust force is delivered by two magnets MG that repel one another instead of the compression spring. For example, one magnet is fixed to the bracket 55 and the other is mounted on the rod. The device also comprises a bar between the anchor 16 and the bracket 55 fixed to the premolar, immobilizing the premolar and preventing the parasitic effect of the reaction force with the magnet fixed to the bracket.

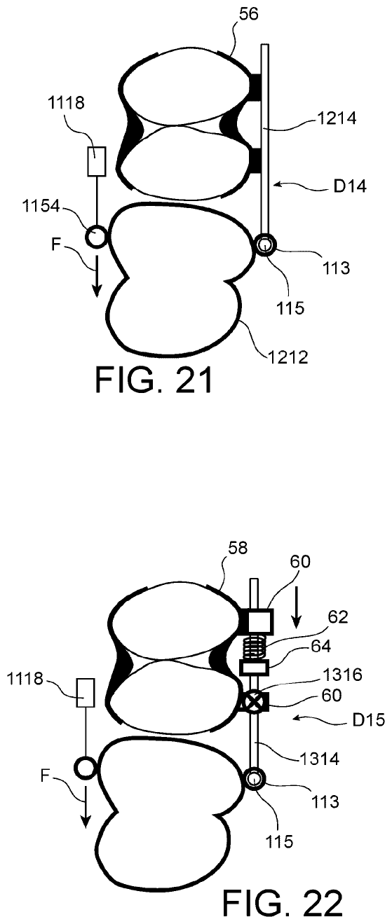

In FIG. 21 can be seen a vestibular displacement device D14 according to another embodiment in which the fixed element 1214 is intended to be fixed to a premolar or premolars or a deciduous molar. For example, a ring or bracket 56 is bonded to the premolar or premolars, the fixed element comprises a rod fitted with a pin 115 received in a housing 113 of the ring 1212 secured to the molar.

The means of applying the distal force 1118 are similar to those described relative to the device D13.

In FIG. 22 can be seen another example of a vestibular displacement device D15 able, in addition to applying a distal rotation to the molar, of applying a distal or mesial translation to it, allowing the mesiopalatal cusp to be replaced in its antagonistic fossa.

In this example, the device is anchored to the neighboring teeth.

In this example, the bracket 58 fixed to the neighboring teeth comprises two fixed collar-type supports 60 aligned so as to fix the direction of rod 1314 and in which the rod 1314 slides. The rod 1314 carries the pin 115.

Means are provided to ensure axial immobilization of the rod 1314, for example, a screw 1316 passing through one or both collars.

A translation spring 62 is mounted about the rod 1314 between one collar and a slide 64 slidably mounted between the two collars. The translation spring 62 pushes on the slide 64, which is fixed to the rod 1314, and causes the rod 1314 to slide, resulting in a distal translational movement of the pin 115, which is received in the housing 113. When a mesialization movement is desired, the spring will be attached to the slide 64 and the support 60. By stretching the spring, the slide 64, which is fixed to the rod 1314, will cause the rod 1314 to slide, resulting in a mesial translational movement of the pin 15, which is received in the housing 113.

Preferably, at least one of the two parts has a rectangular or square cross-section to avoid relative rotation of the two parts about their axis.

The means of applying the distal force 1118 are similar to those described in relation to the device D18.

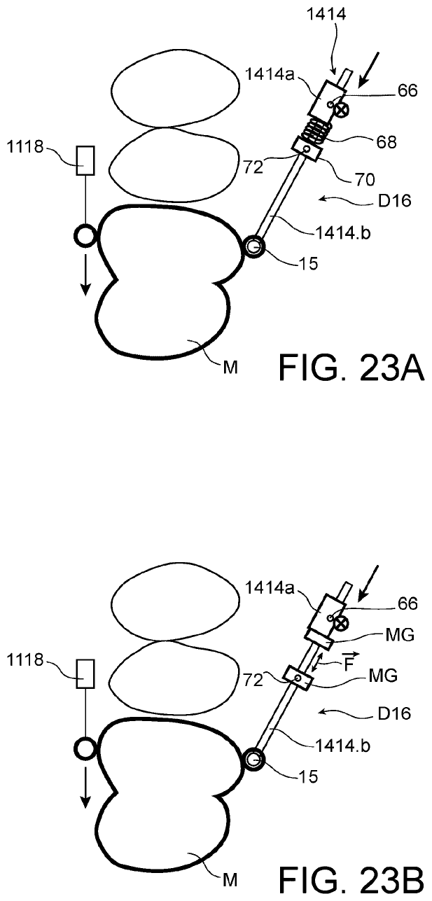

In FIG. 23A can be seen another example of a vestibular displacement device D16, also able to apply a distal rotation to the molar to apply a distal or mesial translation allowing the mesiopalatal cusp to be replaced in its antagonistic fossa.

The device D16 comprises a fixed element 1414 comprising a first part 1414.a which is a sleeve intended to be anchored to a palate bone and a second part 1414.b formed by a rod carrying the pin 15 and sliding in the first part 1414.a (sleeve). A screw 66 allows the rod 1414.b to be immobilized in the sleeve 1414.a.

A spring 68 is mounted in compression between the first part 1414.a and the second part 1414.b.

In addition, the device D16 comprises means for loading the translation spring 68. In this example, these means comprise a slide 70 slidably mounted on the rod 1414.b between the molar M and the fixed sleeve 1414.a. The translation spring 68 pushes on the slide 70, which is fixed to the rod 1414.b, and causes the rod 1414.b to slide, resulting in a distal translational movement of the pin 115.

The slide 70 comprises a screw 72 to immobilize it axially to the second part 1414.b defining a load level of the spring 68.

Preferably, the first part 1414.a and the second part 1414.b are such that they are rotationally immobilized relative to each other, for example they have a square or rectangular cross-section.

The means of applying the distal force are similar to those described in relation to the device D13.

In FIG. 23B can be seen a variant of the device in FIG. 23A, in which the spring is replaced by two magnets MG, which repel or attract one another.

As a variant, the pin or the housing can be supported by a bracket which is bonded to the tooth by a resin. Advantageously, the bracket is produced by additive manufacturing, also referred to as 3D printing.

Palatal and vestibular displacement devices according to the invention can be produced by assembling parts by welding, screwing or bonding, with the portions being produced by cutting and machining. As a variant, the devices can be made at least in part by additive 3D manufacturing.

It will be understood that in all the embodiment examples, the pin can be carried by the rod or by the ring and the housing can be carried by the ring or by the rod respectively. Furthermore, all the embodiment examples comprise a rod which can be anchored either to a palate bone or to one or more neighboring teeth, preferably the premolars or the premolar and a deciduous molar.

In the examples described, the displacement devices comprise two parts, one fitted with a pin and the other with a housing, the two parts being assembled when the pin is mounted into the housing when the device is placed on the molar of the patient, this realization facilitates assembly. Indeed, on the one hand, the pin is anchored to the palate or a neighboring tooth, and on the other, the ring or other support is fixed to the molar. As a variant, the device can be supplied to the orthodontist already assembled before fitting.

It will be understood that any means capable of exerting a rotational torque or translational force does not fall outside the scope of the present invention.

1. A device for displacement of an upper molar comprising a mesiopalatal cusp, comprising:
a support intended to be fixed to the upper molar,
a rod comprising a first end intended to be anchored to a palate bone or to at least one tooth adjacent to the upper molar so that, when the device is in place, the rod has a given position relative to the upper molar,
a rotational hinge between the support and the rod, said rotational hinge comprising an axis of rotation intended to be fixed relative to said rod and to be perpendicular to the occlusal plane, said axis of rotation being intended to be arranged close to the mesiopalatal cusp of the upper molar,
and a rotation device configured to apply a force able to rotate said upper molar about the axis of rotation, so that said upper molar has a distal rotation, said force being applied either to the palatal face of the molar or to a vestibular face of the molar.

2. The displacement device according to claim 1, wherein the rod comprises a pin intended to form the axis of rotation and the support comprises a housing for said pin or the support comprises a pin intended to form the axis of rotation and the rod carries a housing for said pin, the pin and the housing assembly forming the rotational hinge.

3. The displacement device according to claim 2, wherein the rotation device is configured to apply the force to the palatal face of the molar able and wherein said rotation device comprises at least one torsion spring comprising coils and two radially extending strands, said coils being mounted on the pin, one strand being fixed to the support and the other strand being fixed to the rod, the attachment of the other strand to the rod causing the spring to be loaded.

4. The displacement device according to claim 3, wherein the housing comprises a lateral opening over its height, allowing the coils to be positioned by transverse displacement of the spring, said housing comprising a transverse slot for the passage of the strand attached to the support.

5. The displacement device according to claim 2, wherein the rotation device comprises a tension spring intended to be fixed by a first end intended for a palate bone or to a neighboring tooth or teeth, and is fixed to the support at a location distinct from that of the pivot hinge.

6. The displacement device according to claim 2, wherein the rotation device comprises a tension spring mounted about the rod, fixed by a first end to the rod on the side of its first end, the device also comprising a bar, one end of which slides along the rod and one end of which is fixed to the support at a location distinct from that of the pivot hinge, the second end of the spring being fixed to the end of the bar sliding on the rod.

7. The displacement device according to claim 1, wherein the rod comprises a pin intended to form the axis of rotation and arranged close to the mesiopalatal cusp of the upper molar, wherein the rotation device is configured to apply the force to the palatal face of the molar and wherein said rotation device comprises at least one torsion spring comprising coils and two strands, said coils being mounted on the pin, said device being configured to be connected to the support by means of one strand of the torsion spring.

8. The displacement device according to claim 1, wherein the rotation device comprises a part articulated in rotation on the support, said part being located on the vestibular face of the molar, and elastic means or repulsive magnets exerting a force on said articulated part.

9. The displacement device according to claim 8, wherein the rotation device is configured to apply the force on the vestibular face of the molar and wherein said rotation device is configured to be anchored between two teeth or to the zygomatic bone or are extra-oral and are fixed to the skull or nape of the patient.

10. The displacement device according to claim 1, comprising a translation device configured to apply a force able to displace in translation said upper molar.

11. The displacement device according to claim 10, wherein the translation device comprises a translation spring or magnets oriented relative to one another so as to repel or attract one another depending on the desired action.

12. The displacement device as claimed in claim 11, wherein the rod comprises a first part and a second part configured to slide relative to one another, and wherein the translation spring is mounted on the rod between the first part and the second part, or the magnets are mounted on the first part and the second part.

13. The displacement device according to claim 12, wherein the first part and the second part have cross-sections such that they prevent relative rotation about their axis.

14. The displacement device according to claim 12, wherein the spring is fixed by one end to the first part and by another end to the second part, the relative position of the first part and the second part allowing the translation spring to be put into compression or tension.

15. The displacement device according to claim 12, comprising a shroud covering at least the translation spring and forming the first part or the second part.

16. The displacement device according to claim 11, comprising a shroud covering at least the translation spring and forming the first part or the second part.

17. The displacement device according to claim 1, wherein the support is a ring intended to be mounted about the first upper molar.

18. The displacement device according to claim 17, comprising a bracket configured to be fixed to one or more teeth adjacent to the first upper molar, to which the first end of the rod is fixed.

19. The displacement device according to claim 3, wherein the support is a ring intended to be mounted about the first upper molar.

20. The displacement device according to claim 9, wherein the support is a ring intended to be mounted about the first upper molar.

21. The displacement device according to claim 13, wherein the spring is fixed by one end to the first part and by another end to the second part, the relative position of the first part and the second part allowing the translation spring to be put into compression or tension
